(19) United States
(12) Patent Application Publication
(10) Pub. No.: US 2002/0055869 A1
(43) Pub. Date: May 9, 2002

(54) Housing market analysis method

(76) Inventor: David Hegg, St. Anthony, MN (US)

Correspondence Address: JANET PEYTON SCHAFER, SCHAFER LAW OFFICE PA, 727 TORCHWOOD CIRCLE, NEW BRIGHTON, MN, 55112, US

(21) Appl. No.: 09/761,455

(22) Filed: Jan. 16, 2001

Related U.S. Application Data
(60) Provisional application No. 60/176,400, filed on Jan. 13, 2000.

(51) Int. Cl. G06F 17/60

(52) U.S. Cl. 705/10

(57) ABSTRACT

This invention is a method by which a housing market analysis can be made to produce a set of expected value groupings of a total population from information obtained from sample populations. The method includes using a ratio, called the median ratio, which is the mean divided by the median, together with traditional statistical procedures of standard deviation and ratio probability density distribution, to obtain a set of value groupings for a total population. In the specific example of average real estate sales, whereby the median of real estate sales a market analysis can be determined from the sample from which is computed the ratio probability density distributions which can then be used by an entity, be it governmental, private business, land developers, financial lenders, housing suppliers or others, to determine present housing needs and anticipate future housing requirements.

This application, filed under 35 U.S.C. §111(a), replaces the provisional application, serial No. 60/175,400 filed Jan. 13, 2000 under et U.S.C. §111(b). Applicant claims benefit of the earlier filing date under 35 U.S.C. §120.

### BACKGROUND

The present invention is directed to a method having a first step of abstraction, from sample data, a ratio probability density distribution which can be used to model experiments or events. In this step, a set of ratios is computed from the mean and median of the sets of sample data and then this data is organized in a systematic way. Using a formula [1−1÷(½ grouping number×½grouping number)] for determining the groupings right of the median above the number observable in the groupings, these new groupings being the ratio probability density distributions to form a set of expected statistics from the sample data. By attaching the ratio probability density distributions to sets of sample data, matching the entry values, median values, average values and total values of the same population, one can compare the expected number of statistics within each number grouping with the actual number of statistics found in the same grouping and make statistical inferences as to past, present and future real estate needs.

Various prior art patents have utilized a method and apparatus for monitoring the strength of a real estate market. For example, Rothstein U.S. Pat. No. 6,058,369, is illustrative of such prior art. Rothstein utilizes average selling prices and includes expired listings. The invention of this application requires a median value be determined in addition to the average value and disregards expired listings. Further, unlike other prior art, the method of this invention permits the attachment of Baysian probabilities to its output.

While this prior art may be suitable for the particular purpose to which it addresses, it would not be as suitable for the purpose of the present invention as hereinafter described.

### SUMMARY

The present invention is directed to a housing market analysis method that satisfies the needs for an entity, be it governmental, private business, land developers, financial lenders, housing suppliers or users, to determine present housing needs and anticipate future housing needs. A method having features ofthe present invention comprises abstraction of data from a public source, such as governmental census info, or newspaper ads. The data is then developed into a probability density distribution which can be used to model experiments or events. The method ofthis invention involves first computing a set of ratios derived from the mean and median of sets of data and organizes these ratios in a systematic way. These ratios, called median ratios where each is determined by dividing the mean by the median, are organized as a ratio probability density distribution to which is attached to sample data in a manner so as to form a set of expected statistics from the sample data being analyzed. In attaching a ratio probability density distribution to the sample data, standard deviations of the sample data set are disregarded while the grouping probabilities are retained. In attaching the ratio probability density distribution to the sample data sets, the ratio probability density distribution is matched in such a manner so that the sample data and the ratio probability density distribution have the same population, the same entry value, the same median value, the same average value and hence the same total value. Once the ratio probability density distribution has been attached, we can then compare the expected number of statistics within each number grouping and compare it with the actual number of statistics found in the same grouping and make statistical inferences that gain us insight into past, current and future events such as housing needs.

A method of analysis of statistical data to produce a set of expected value groupings of a total population from information obtained from sample populations having the steps of calculating a ratio where the mean of a sample population is divided by the median of the sample population, this ratio is called a median ratio. Calculating, from a collection of the median ratios, the standard deviation of all of the ratios of the sample population. Dividing the standard deviation of all of the ratios of the sample population by four. Establishing a median ofthis series of ratios and establishing groupings by moving in each direction from this median of median ratios by an amount determined as described above. Next a ratio probability density distribution is calculated by dividing the actual number of ratios found in each grouping by the total of all ratios. Repeating these steps for several sample populations and reducing the resulting relative frequency distributions allows one to develop a single composite relative frequency distribution figure. Using this ratio probability density distribution figure and attaching it to a set of lowest value, the median value, the average value of the sample population and adjusting to form an identical statement between relative frequency distribution formed as described above, to the sample distribution being analyzed, enables one to compare within groupings the expected to the actual number found.

A method of analysis of statistical data by which a housing market analysis can be made to produce a set of expected value groupings of a total population from information obtained from sample populations, comprising the steps of using a median statistic and an average statistic in the sample, calculating a median ratio. Calculating a standard deviation of these median ratios. Dividing the standard deviation of the median ratios by four (4). Using the median of the median ratios, establish groupings by moving in each direction from this median of the median ratios by the amount determined above, these groupings being the ratio probability density distributions. Combining the ratio of the groupings where more than one median ratio is involved, by inspection and selection of a probability for a specific grouping, so that the sum the of the probabilities selected total 50 percent for all groupings below the median and 50 percent for all groupings above the median. Using a formula 1−1÷(½ grouping number×½ grouping number) for determining the groupings right of the median above the number observable in the groupings, these new groupings being the ratio probability density distributions to form a set of expected statistics from the sample data. Attaching the ratio probability density distribution to the sample data by matching the entry values, median values, average values and total values of the same population. Comparing the expected number of statistics within each number grouping and compare it with the actual number of statistics found in the same grouping and making statistical inferences as to past, present and future real estate needs.

It is an object of the present invention to provide a method by which a housing market analysis can be made to produce a set of expected value groupings of a total population from information obtained from sample populations.

It is a further object of the present invention to provide a method by which a probability density distribution can be developed for use in making statistical inferences with a special ability to manage skewed sample data sets.

The various features of novelty which characterize the invention are pointed out with particularity in the claims annexed to and forming a part ofthis disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

Understanding ofthe invention will be enhanced by referring to the accompanying drawings, in which like numbers refer to like parts in the several views and in which:

FIG. 1 illustrates a composite graphic representation of the expected rental rates and numbers of studio, one bedroom, two bedroom, three bedroom, and four bedroom apartments in the Seattle, Wash. rental market on Jan. 6, 1996.

### DETAILED DESCRIPTION OF THE CURRENTLY PREFERRED EMBODIMENTS

Understanding of the invention will be further enhanced by referring to the following illustrative but non-limiting example. This invention sets forth a method of attaching a ratio probability distribution which in the first instance sets for the two distinct sets of data, one to the left of the median computed in a certain way, which is different from data computed in a separate method for data on the right side ofthe median. This method further includes moving away from the median in equal segments in the initial attachment of the ratio probability density.

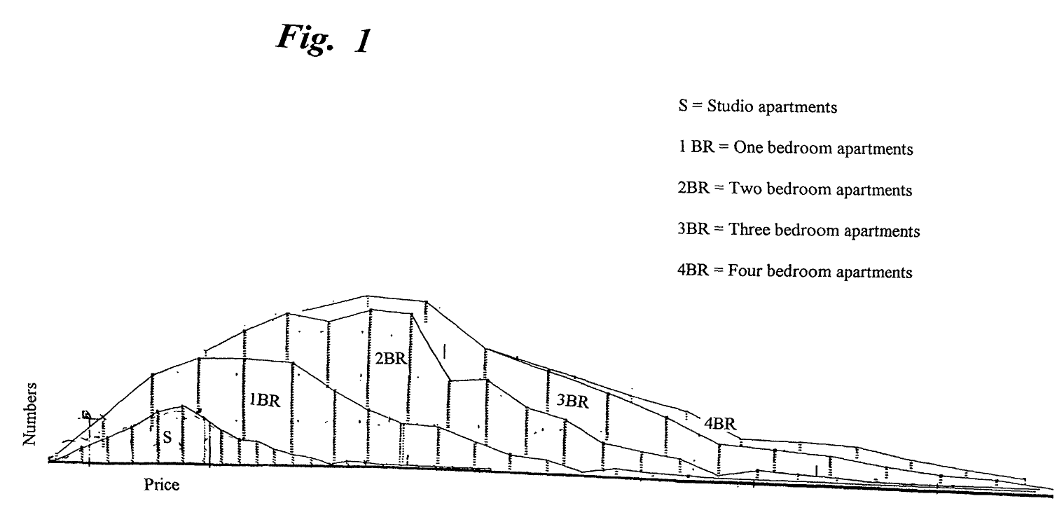

Turning now to the drawings, in which like reference characters refer to corresponding elements throughout the several views, FIG. 1 illustrates a composite graphic representation of the rental rates for studio, one bedroom, two bedroom, three bedroom, and four bedroom apartments in the Seattle, Wash. rental market on Jan. 6, 1996, illustrating the sample data for each bedroom subset, which when graphed together collectively, form the same shape as the shape of all the market rents regardless of bedroom type.

A median ratio is determined in a single experiment by dividing the mean by the median. Example A illustrates this.

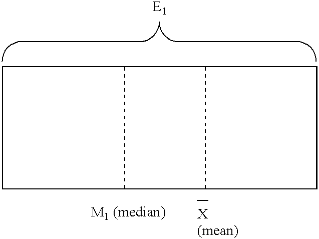

When you have conducted a large number of experiments, (El . . . En) and you take all of the ratios calculated for each and put them together, there exists for the combined set of ratios a median. In Example B, the median of the set of ratios is M. An example of such a collection of data is shown at Example 1, following.

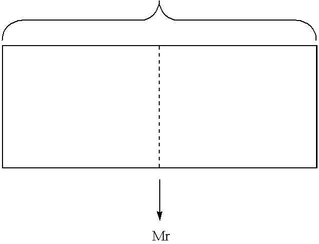

There exists a median Ratio Mr for the set of ratios Rl . . . Rn from the experiments El . . . En. EXAMPLE 1

1990 Congressional Districts

| | Median | Average | | |
|---|---|---|---|---|
| Experiments E | Rent | Rent | | Ratio |
| 1 Mass.10 | 651 | 636 | 1 | 0.977 |
| 2 Virg.03 | 398 | 390 | 2 | 0.980 |
| 3 Mass.02 | 497 | 489 | 3 | 0.984 |
| 4 Mass.06 | 617 | 608 | 4 | 0.985 |
| 5 Mass.07 | 685 | 679 | 1 | 0.991 |
| 6 Florida 03 | 372 | 369 | 2 | 0.992 |
| 7 New Jers.01 | 514 | 510 | 3 | 0.992 |
| 8 Mass.03 | 515 | 511 | 4 | 0.992 |
| 9 RhodeIs.2 | 498 | 495 | 5 | 0.994 |
| 10 Mass.05 | 603 | 600 | 1 | 0.995 |
| 11 Maryland 7 | 432 | 430 | 2 | 0.995 |
| 12 N.Carol.12 | 381 | 380 | 3 | 0.997 |
| 13 Penn.17 | 415 | 414 | 4 | 0.998 |
| 14 Mich.16 | 456 | 455 | 5 | 0.998 |
| 15 New Jers.02 | 525 | 524 | 6 | 0.998 |
| 16 New Jers.10 | 520 | 520 | 1 | 1.000 |
| 17 Conn. 3 | 623 | 623 | 2 | 1.000 |
| 18 Mass.01 | 479 | 480 | 3 | 1.002 |
| 19 Georgia 03 | 447 | 448 | 4 | 1.002 |
| 20 Georgia 11 | 409 | 410 | 5 | 1.002 |
| 21 Wiscon.1 | 401 | 402 | 6 | 1.002 |
| 22 Ohio 11 | 376 | 377 | 7 | 1.003 |
| 23 Ohio 17 | 337 | 338 | 8 | 1.003 |
| 24 Mass.09 | 616 | 618 | 9 | 1.003 |
| 25 Mich.10 | 471 | 473 | 10 | 1.004 |
| 26 Georgia 05 | 461 | 463 | 11 | 1.004 |
| Tenn.5 | 430 | 432 | 1 | 1.005 |
| 399 Dist.of.C.1 | 479 | 538 | 1 | 1.123 |
| 400 Colo. 3 | 361 | 406 | 1 | 1.125 |
| 401 Mass.04 | 512 | 576 | 2 | 1.125 |
| 402 Texas07 | 475 | 538 | 1 | 1.133 |
| 403 Maryland 8 | 777 | 882 | 1 | 1.135 |
| 404 Texas03 | 534 | 607 | 2 | 1.137 |
| 405 NewYork 08 | 544 | 633 | 1 | 1.164 |

| | | | STD 0.0274826145 | |
|---|---|---|---|---|
| Total | 196,722 | 205,609 | | |
| Sample No | 432 | 432 | | |
| Average | $455.38 | $475.95 | | Median Ratio |

( MR )1.0412371134

Illustrated in Example C is the standard deviation of the ratios from all of the experiments (El . . . En). In this Example, “R std” is identified as the ratio standard deviation. Also illustrated in Example C is the initial method for determining groupings to be used for computing the ratio probability density distribution. This value is found by dividing the standard deviation by four. Thus, each initial grouping will represent ¼ the ratio standard deviation. For the experiment: El . . . En there exists a standard deviation (std) of Rl . . . Rn called the R std.

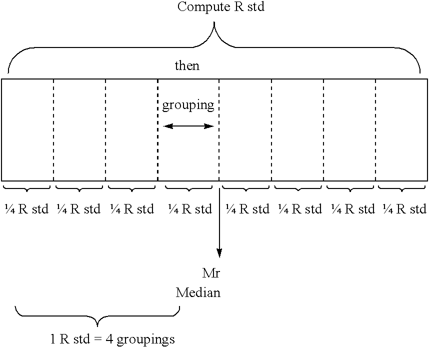

### EXAMPLE 2

Computing the Ratio of the Average Rent, divided by the Median Rent Found in each Congressional District Reported in the 1990 US Census Steps.

1 Calculate Ratio for each Congressional District;

2 Calculate Standard Deviation of Ratios;

3 Divide the Standard Deviation of Ratios by the number four;

4 Establish groupings by moving in each direction from the Median by amount determined from step 3.

1.041237 Median

0.027482 Standard Deviation

4 Required in the Initial Stage

0.006870 Standard Deviation Divided by four

1.034366 First Boundry line below Median Ratio

1.027495 Second Boundry Line below Median Ratio

Use same proceedure going the other direction from median to establish areas to right of median

In Example D, the number of classes or groupings are formed and indicate the location of the class boundaries by beginning at the median of the distribution of ratios (Mr) and moving in each direction away from the median ratio, subtracting or adding the value computed in Example C (¼ R std) to or from the median to develop the boundaries of each grouping.

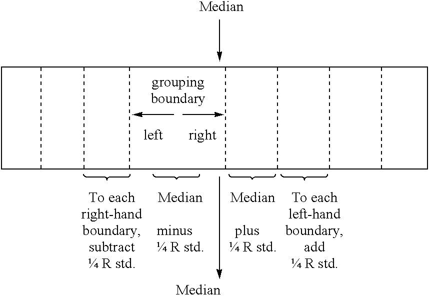

Illustrated in Example D are the number of ratios found within each grouping as a result of counting the number of ratios in the sample set within each group's boundaries and assigning them to their specific grouping.

Illustrated in Example E where G represents a grouping, the G+1 represents the first grouping to the right of the median, and G−1 represents the first grouping to the left of the median. G+2 represents the second grouping to the right of the median and so forth.

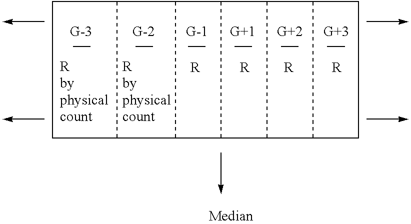

In Example F are illustrated the percentage of ratios found in each class marker as it relates to the total of all ratios found. This is the relative frequency of the distribution of each grouping ratio as it relates to the total of all ratios and hence the basis of the ratio probability density distribution. R is the number of ratios found in a specific grouping, Rs equals the total of all the ratios in the experiment El. For each grouping R/Rs equals a percentage for each of the groupings.

EXAMPLE F

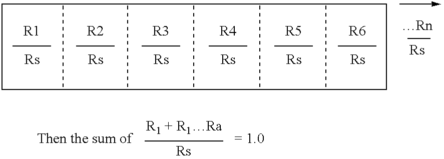

In Example G is illustrated the first step in the procedure to consolidate different distributions of ratios by inspection, and comparison of the percentage of the area found in the different ratio distributions. This method assigns the probabilities for the combined grouping. These probabilities are called the Ratio Probability Density Distribution (RPDD).

This is first done by labeling each grouping with a number, starting with the number one and then moving in each direction from the median. Thus the second grouping below the median would be G−2 and the second grouping above the median would be G +2.

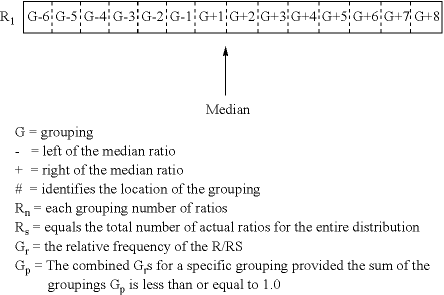

In Example H is illustrated the method of combining the ratio probability density distribution where more than one distribution is involved. This method is done by inspection and selection of a probability for a specific grouping so that the sum of the probabilities selected total 50% for all groupings below the median and 50% for all groupings above the median.

### EXAMPLE H

EXAMPLE H
Ratio Probability Density Distributions (RPDD)

| | | |
|---|---|---|
| RPDD #A | Grouping # | 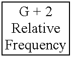 |
| RPDD #B | Grouping # | 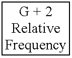 |
| RPDD #C | Group # | 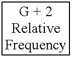 |
| Then assigned probability for grouping G + 2 is Gₚ of | Combined Grouping Probability Gₚ | 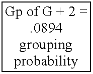 |

EXAMPLE 3
Method for Combining Probability Density Distributions

| Drawing | Claim One | | | | |
|---|---|---|---|---|---|
| Relative | Frequency | Distribution | | Selected | Selected |
| Grouping | 1980 | 1990 | 1990 | By | By |
| No. | Incomes | Incomes | Rents | Inspection | Formula |
| 10 | | | 0.0023 | 0 | |
| 9 | | | 0.0069 | 0 | |
| 8 | 0.0023 | | 0.0093 | 0 | |
| 7 | 0.0023 | | 0.0208 | 0 | |
| 6 | 0.0138 | 0.0092 | 0.0301 | 0.0086000 | |
| 5 | 0.0413 | 0.0252 | 0.0486 | 0.0384000 | |
| 4 | 0.0895 | 0.0459 | 0.0671 | 0.0677000 | |
| 3 | 0.0986 | 0.0963 | 0.0880 | 0.0959850 | |
| 2 | 0.1284 | 0.1445 | 0.0926 | 0.1368150 | |
| 1 | 0.1239 | 0.1789 | 0.1343 | 0.1525000 | |
| 0 | | | 0 | | |
| 1 | 0.1239 | 0.1216 | 0.1088 | 0.1227500 | |
| 2 | 0.0963 | 0.0826 | 0.0903 | 0.0894000 | |
| 3 | 0.0550 | 0.0803 | 0.0926 | 0.0676500 | |
| 4 | 0.0482 | 0.0803 | 0.0532 | 0.0642500 | |
| 5 | 0.0390 | 0.0436 | 0.0417 | 0.0413000 | |
| 6 | 0.0436 | 0.0115 | 0.0231 | 0.0275000 | |
| 7 | 0.0275 | 0.0161 | 0.0255 | 0.0218000 | |
| 8 | 0.0161 | 0.0183 | 0.0139 | | 0.0028500 |
| 9 | 0.0069 | 0.0092 | 0.0139 | | 0.0131173 |
| 10 | 0.0115 | 0.0069 | 0.0162 | | 0.0093827 |
| 11 | 0.0115 | 0.0046 | 0.0046 | | 0.0069421 |
| 12 | 0.0023 | 0.0046 | 0.0023 | | 0.0052801 |
| 13 | 0.0023 | 0.0023 | 0.0046 | | 0.0041091 |
| 14 | 0.0023 | 0.0023 | 0.0069 | | 0.0032605 |
| 15 | 0.0069 | 0.0046 | 0 | | 0.0026304 |
| 16 | 0.0023 | | 0 | | 0.0021528 |
| 17 | 0.0023 | | 0 | | 0.0017842 |
| 18 | | | 0.0023 | | 0.0014952 |
| 19 | | 0.0023 | | | 0.0012653 |
| 20 | | 0.0046 | | | 0.0010803 |
| | | | | | 0.0009297 |
| | | | | | 0.0008058 |

In Example I is displayed the sum of the probabilities of the total of the first 13 groupings determined by the procedure illustrated in Example H (six groupings below the median, and seven groupings above the median), the sum is 93.465%.

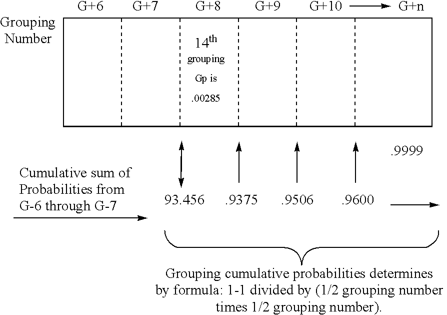

Part of the method of this invention is the development of a formula for determining the probabilities for the groupings right of the median, above the number seven grouping. Determining the probabilities is done by taking the next group number (8 in this case) and dividing it in half, then inserting this number into the formula: one minus one divided by (one half of the group marker times on half of the group marker).

Thus grouping marker +8 divided by 2 is 4 and 1−1÷4×4+0.9375 (See G+8 in Example I).

It follows then that if the cumulative probabilities of the first 13 groups is 93.465%, and 93.75% through 14 groupings (G−6 to G+8), then the relative frequency for the 14th grouping (number 8 right of the median) is the difference between 93.75 and 93.456 or 0.2850% (0.9375-0.9346=0.002850). Note: The cumulative probabilities of the Ratio Probability Density Distribution approaches 100% but never reaches it.

We then attach the Ratio Probability Density Distribution (RPDD), which has been developed in the preceding examples, in a manner so as to form a set of expected statistics from the sample data being analyzed. The RPDD has a fixed portion, the range of values to the left of the median G−6 through G−1 in the example 2, and a flexible portion, the range of values to the right of the median G+1 through G+n. In attaching the RPDD to the sample data, the standard deviation of the sample data is disregarded while the grouping probabilities are retained.

In attaching the RPPD to the sample data, the expected probabilities of the RPDD are matched in such a manner so that the sample data and the RPDD have the same population, the same entry value, the same median value and the same average value. Once the RPDD has been attached, we then can compare the expected number of statistics within each number grouping and compare it with the actual number of statistics found in the same grouping and make statistical inferences that gain us insight into past, current and future events. Example J illustrates the initial steps required to attach the RPDD to the sample set of data formed in the manner described. From the sample set first must be determined the following values: the smallest value (called the entry value), the median value, the average value, the population size (the number of values found in the sample) and the total of all values.

In Example K is illustrated the attachment of the RPDD at the point of the entry value and the median value. This is done by placing the six groupings below the median in a manner so that the entry value matches the left side of grouping number six, and the median value matches the right side of the first grouping left of the median. In this example, if the distribution of rental ads in a local newspaper on a certain day, the RPDD has been attached in a way so that if the entry value of the data is $400 and the median value is computed at $450, the RPDD would divide up the distance between $00 and $450 into six equal segments. Please note that this would be six segments of equal length of $8.33 ($450−$400÷6 equals $8.33).

### EXAMPLE K

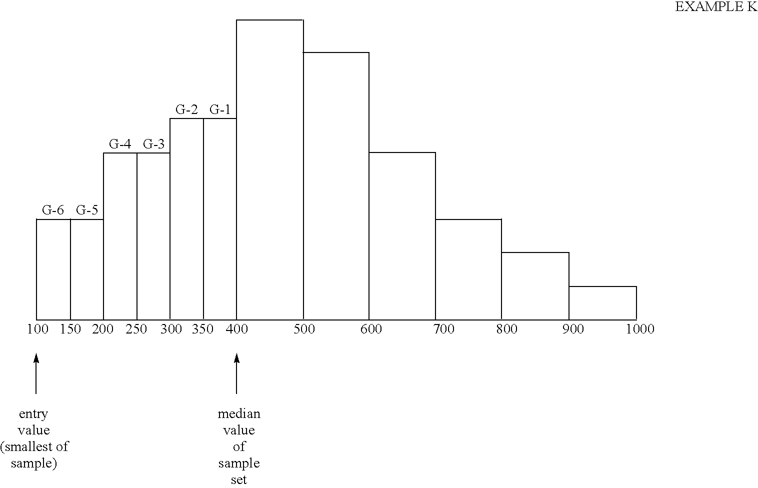

In Example L is illustrated the expected number of articles, or items to be found in each grouping established by using probabilities developed using the steps in Example H, as shown in Example 3. This is done by multiplying the probabilities for each grouping times the population of the sample. From Example K above, for the range of values from $400.00 to $408.33 we expect 0.0086 of the sample population values to fall in the grouping number six left of the median. We then expect 0.0384 of the sample population to fall in the fifth grouping of values left of the median ($408.33 to $416.66). If the sample population contains 200 values, then the grouping number six left ofthe median with rents from $400.00 to $408.33 would be expected to contain 1.72 values (200×0.0384) and the next grouping from $408.33 to $416.66 would be expected to contain 7.68 of all values from the same (200×0.0384). By the time we reach the median half of all values (100) will fall in one of the six groupings between $400.00 and $450.00.

EXAMPLE L

| | | | |
|---|---|---|---|
| | | | Probability |
| | | | Grouping |
| | | Grouping | Number |
| | | G − 4 | G − 3: 0.95985x |
| | Grouping | Probability | G − 2: 0.136815x |
| | G − 5 | .0677 | G − 1: 0.1525x |
| Grouping | Probability | times | G + 1: 0.12275x |
| G − 6 | .0384 | sample | G + 2: 0.0894x |
| Probability | times | population x | G + 3: 0.06765x |
| .0086 | sample | equals | G + 4: 0.06425x |
| times | population x | .0677x | G + 5: 0.0413x |
| sample | equals | expected | G + 6: 0.0275x |
| population x | x.0384x | articles | G + 7: 0.0218x |
| articles | expected | | G + 8: 0.00285x |
| .0086x | articles | | G + 9: by formula |

Gₙ by formula x

Example M illustrates the method of attaching the RPDD over the sample data to the right of the median. This is done by matching the entry value, median, average value and total population value of the sample population with the expected average value of the RPDD for the sample population.

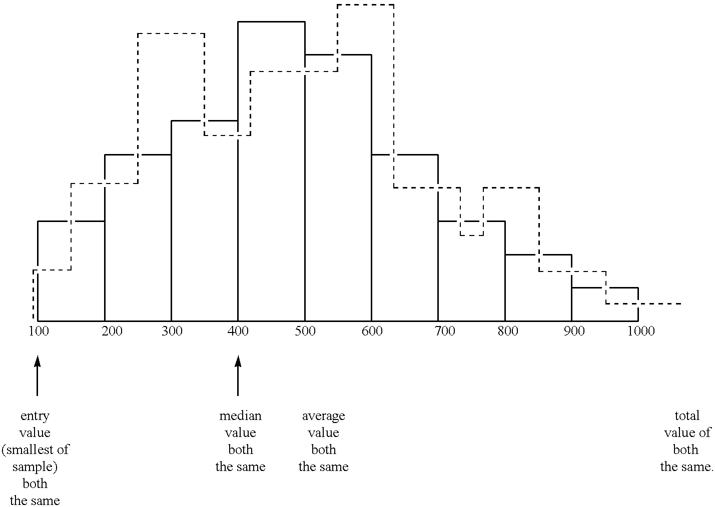

In Example M is illustrated the expected total values of the RPDD for the entry to the median. This is done by taking the intermediate value (defined as the sum of the two range values at the opposite ends of a grouping, divided by two) of each grouping range between the entry value and the median and multiplying that value time the number of expected statistics to be found in the sample population (determined by multiplying the probabilities of each RPDD grouping times the sample population) and label this total the area to median expected.

Continuing the illustration of Example K, if the range of grouping number 6 left of the median (G−6) is from $400.00 to $408.33, add the two together and divide by two to get an intermediate value (here $404.17), the intermediate value is then multiplied by the number of expected values in the grouping (1.72×$404.17) for a total expected value of rents in the first grouping of $695.00. This step is repeated for each grouping between the entry value and the medain so for example in grouping two (G−2), the intermediate value of the second grouping is $408.33+$416.66 divded by two equals $412.50×7.68 expected values in the second grouping for a total expected value of the second grouping of $3,168.00 in rents. By doing this for each grouping and then adding all the sum of the expected rents of the first six groupings, we total $43,369.00. This is the area to median expected, the value one would expect to find if we totaled all the rents from the entry rent to the median rent of the sample population. This is demonstrated at Example N, following. Please note: this is not the sum of the actual rents between the entry rent and the median rent, only the sum of what we expect to find.

This area to median expected is useful to check, along with the chi-square test, the accuracy of the expected values as representational of market behavior. The assumption is that the expected area to median will sum to the actual area to median over a large number of sample populations.

### EXAMPLE N

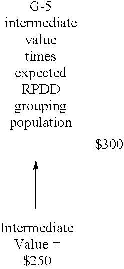

In Example O is illustrated the method of attaching the RPDD to the sample population that exists to the right of the median value. This is done by increasing or decreasing (expanding or shrinking) the range of values of each grouping to the right of the median in a uniform manner (at the same rate of increase across all ranges within and between the groupings) until the sum of the area to median expected, together with the sum of the grouping of expected values to the right of the median, equals the total value of the sample population. In determining the total value of each grouping right of the median to be summed, use the us the same procedure as illustrated in Example N where the range of values in each grouping is taken from on end of the grouping, added to the value at the end of the range of the same groping and divided by two to calculate the intermediate value. Then multiply it by the expected number of values determined for that group to arrive at the total, then sum all groupings to achieve a grand total.

If the total rents of the sample population is $96,200 then expand or contract the range of the values of the groupings to the right of the median until the sum of the total expected rents from area to median expected ($43,369.00) plus the sum of the expected values for the area to the right of the median, equals $96,200.00.

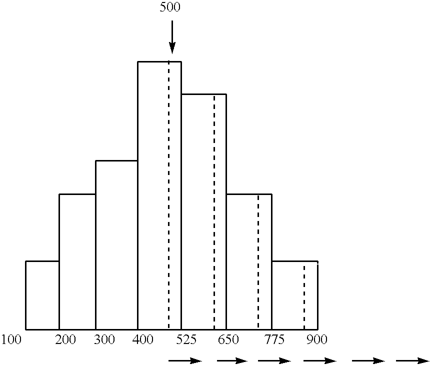

In Example P is illustrated the method of examining each grouping to compare the expected number of items in the grouping with the actual number of items found in the grouping. This is the output of the invention.

EXAMPLE P

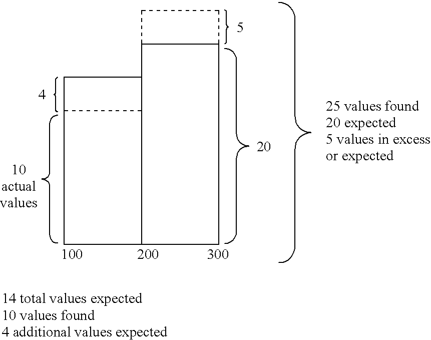

The above describes a method of obtaining and analyzing data. This information can be used for a variety of purposes. For example, rental move-in rate and housing ownership move-in rate can both be analyzed in anticipation of housing needs in a community. Examples Q - R following illustrate the how gathering this information and analyzing it can increase the real estate knowledge of the government entity.

### EXAMPLE Q

| OSAKIS | | 1999 | | 15 | | |
|---|---|---|---|---|---|---|
| Expected | | Expected | 1999 | Current | Expected Sales | |
| Sales Price | | Sales | Actual | Visable | Distribution | |
| From | To | Dist. | Sales | Supply | Next 70 Sales | Sales |
| $12,100 | $18,917 | 0 | 1 | | | |
| $18,918 | $25,733 | 1 | 2 | | $21,188 $28,821 | 3 |
| $25,734 | $32,550 | 2 | 4 | | $28,822 $36,456 | 5 |
| $32,551 | $39,367 | 3 | 1 | 3 | $36,457 $44,091 | 7 |
| $39,368 | $46,183 | 5 | 6 | 2 | $44,092 $51,725 | 10 |
| $46,184 | $53,000 | 5 | 4 | | $51,726 $59,360 | 11 |
| $53,001 | $58,021 | 4 | 1 | | $59,361 $64,983 | 9 |
| $58,022 | $63,042 | 3 | 4 | | $64,985 $70,607 | 6 |
| $63,043 | $68,063 | 2 | 3 | 1 | $70,608 $76,230 | 5 |
| $68,064 | $73,084 | 2 | 3 | 2 | $76,231 $81,854 | 4 |
| $73,085 | $78,104 | 1 | 0 | | $81,855 $87,477 | 3 |
| $78,105 | $83,125 | 1 | 1 | | $87,478 $93,100 | 2 |
| $83,126 | $88,146 | 1 | 0 | | $93,101 $98,724 | 2 |
| $88,147 | $93,167 | 0.1 | 1 | | $98,725 $104,347 | 0 |
| $93,168 | $98,188 | 0.5 | 1 | 1 | $104,348 $109,971 | 1 |
| $98,189 | $103,209 | 0.3 | 0 | | $109,972 $115,594 | 1 |
| $103,210 | $108,230 | 0.2 | 1 | | $115,595 $121,217 | 0.5 |
| $108,231 | $113,251 | 0.2 | 0 | | $121,218 $126,841 | 0.4 |
| $113,252 | $118,272 | 0.1 | 0 | | $126,842 $132,464 | 0.3 |
| $118,273 | $123,292 | 0.1 | 1 | | $132,465 $138,088 | 0.2 |
| $123,293 | $128,313 | 0.1 | 1 | | $138,089 $143,711 | 0.2 |
| $128,314 | $133,334 | 0.1 | | 2 | $143,712 $149,334 | 0.2 |
| $133,335 | $138,355 | 0.1 | | 1 | $149,335 $154,958 | 0.1 |
| $138,356 | $143,376 | 0.1 | | 1 | $154,959 $160,581 | 0.1 |
| $143,377 | $148,397 | 0.0 | | | $160,582 $166,205 | 0.1 |

### EXAMPLE R

| YEAR 2001 and 2002 | | | | | |
|---|---|---|---|---|---|
| OSAKIS CITY | | Expected | Expected Range of | | Expected |
| HOUSING SEEKERS | | Number | Home Prices | | Number |
| Annual | | at Median | at 8.5% APR | | Without |
| Income | | Income of | 28% of Inc. | | Rental |
| From | To | $19,772 | Debt Service | | Shift |
| $0 | $3,294 | 1 | $0 | $9,997 | 0 |
| $3,295 | $6,590 | 3 | $10,000 | $19,997 | 2 |
| $6,591 | $9,885 | 6 | $20,000 | $29,997 | 4 |
| $9,886 | $13,180 | 8 | $30,000 | $39,997 | 5 |
| $13,181 | $16,476 | 12 | $40,000 | $49,997 | 7 |
| $16,477 | $19,772 | 13 | $50,000 | $60,000 | 8 |
| | | | | | 0 |
| $19,772 | $22,019 | 11 | $60,000 | $66,819 | 7 |
| $22,020 | $24,267 | 8 | $66,822 | $73,640 | 5 |
| $24,268 | $26,515 | 6 | $73,643 | $80,462 | 4 |
| $26,516 | $28,763 | 6 | $80,465 | $87,284 | 4 |
| $28,764 | $31,011 | 4 | $87,287 | $94,105 | 2 |
| $31,012 | $33,259 | 2 | $94,108 | $100,927 | 2 |
| $33,260 | $35,507 | 2 | $100,930 | $107,749 | 1 |
| $35,508 | $37,755 | 0 | $107,752 | $114,570 | 0 |
| $37,756 | $40,003 | 1 | $114,573 | $121,392 | 1 |
| $40,004 | $42,251 | 1 | $121,395 | $128,213 | 1 |
| $42,252 | $44,499 | 1 | $128,217 | $135,035 | 0 |
| $44,500 | $46,747 | 0 | $135,038 | $141,857 | 0 |
| $46,748 | $48,995 | 0 | $141,860 | $148,678 | 0 |
| $48,996 | $51,243 | 0 | $148,681 | $155,500 | 0 |
| $51,244 | $53,491 | 0 | $155,503 | $162,322 | 0 |
| $53,492 | $55,739 | 0 | $162,325 | $169,143 | 0 |

This kind of analysis can be used by real estate agents to help their clients, house sellers, to price their houses advantageously in the current market.

This kind of analysis could be used by policy makers to quantify needs for economic diversity. Also this kind of analysis to produce methodology to manage rental vacancy risks by developers and management risks in listing inventories. By knowing the expected number of house sales in a certain price range, the costs of advertising can be better managed.

This kind of analysis can be used by architects and community developers to develop multiple strategies to support community growth. This kind of analysis can further be used to produce models to by used by businesses and public policy makers in strategic planning risk assessment and capital investment. By seeing a model of the effect interest rate changes have on a particular building market affecting purchasing power, a builder can manage product variety to business cycle risk. Further, these analytical models can provide a tool for addressing ideological confrontations directed toward housing industry workers.

Obviously, computer software can be designed to produce these mathematical analyses to speed up the process as compared to manual calculations.

Although the present invention has been described in considerable detail with reference to certain preferred versions thereof, other versions are possible. For example this method of statistical analysis could be used in other areas where statistical data of past events can be collected and manipulated in an attempt to anticipate current and future needs. Therefore, the spirit and scope of the appended claims should not be limited to the description of the preferred versions contained herein.

Changes and modifications in the specifically described embodiments can be carried out without departing from the scope of the invention which is intended to be limited only by the scope of the appended claims.

What is claimed is:

1. A method of analysis of statistical data to produce a set of expected value groupings of a total population from information obtained from sample populations, comprising the following steps:
a) calculating a ratio where the mean of a provided statistic is divided by the median of the sample population, this ratio a median ratio;
b) calculating, from a collection of the median ratios of step (a), the standard deviation of all of the median ratios of the sample population;
c) dividing the standard deviation of all of the ratios of the sample population by four;
d) establishing a median of this series of ratios and establishing groupings by moving in each direction from this median of median ratios by an amount determined from c) above;
e) calculating a ratio probability density distribution by dividing the actual number of ratios found in each grouping by the total of all ratios;
f) repeating steps a - e for several sample populations; and
g) reducing the ratio probability density distributions to a single composite RPDD figure.

2. The method of claim 1, further comprising the steps of:
a) using the composite RPDD figure of claim 1, to a set of lowest value, the median value, the average value of the sample population and adjusting to form an identical statement between ratio probability density distribution formed in step 1 to the sample distribution being analyzed in step two; and
b) comparing within groupings the expected to the actual number found.

3. A method of analysis of statistical data by which a housing market analysis can be made to produce a set of expected value groupings of a total population from information obtained from sample populations, comprising the following steps:
a) using a median statistic and an average statistic in the sample, calculating a median ratio;
b) calculating a standard deviation of these median ratios;
c) dividing the standard deviation of the median ratios by four (4);
d) using the median of the median ratios, establish groupings by moving in each direction from this median of the median ratios by the amount determined in step (c), these groupings being the ratio probability density distribution;
e) combining the ratio probability density distribution (d) for the groupings where more than one median ratio is involved, by inspection and selection of a probability for a specific grouping so that the sum the of the probabilities selected total 50 percent for all groupings below the median and 50 percent for all groupings above the median;
f) using a formula 1−1÷(½ grouping number×½ grouping number) for determining the groupings right of the median above the number observable in the groupings, these new groupings being the ratio probability density distributions to form a set of expected statistics from the sample data;
g) attaching the ratio probability density distributions to RPDD matching the entry values, median values, average values and total values of the same population;
h) comparing the expected number of statistics within each number grouping and compare it with the actual number of statistics found in the same grouping and making statistical inferences as to past, present and future real estate needs.
